(19) United States
(12) Patent Application Publication
(10) Pub. No.: US 2023/0171114 A1
(43) Pub. Date: Jun. 1, 2023

(54) PHYSICAL UNCLONABLE FUNCTION LEVERAGING STOCHASTIC VARIATIONS OF PASSIVE ELEMENTS

(71) Applicant: International Business Machines Corporation, Armonk, NY (US)

(72) Inventors: Dallas Lea, Niskayuna, NY (US); Yann Mignot, Slingerlands, NY (US); Marc A. Bergendahl, Rensselaer, NY (US); Alex Joseph Varghese, Ballston Lake, NY (US); Sean Teehan, Rensselaer, NY (US); Andrew M. Greene, Slingerlands, NY (US); Matthew T. Shoudy, Guilderland, NY (US)

(21) Appl. No.: 17/537,605

(22) Filed: Nov. 30, 2021

(51) Int. Cl. H04L 9/32; H03K 3/03; H03H 7/06; H03H 7/01; H03K 3/037

(52) U.S. Cl. CPC H04L 9/3278; H03K 3/0315; H03H 7/06; H03H 7/0161; H03K 3/037

(57) ABSTRACT

A physical unclonable function (PUF) device includes a ring oscillator, a plurality of band-pass filters, a demultiplexer, and a latch. The ring oscillator generates a frequency signal. Each passive band-pass filter performs filtering on the frequency signal to pass the frequency signal or block the frequency signal. The demultiplexer receives a set of challenge bits and delivers the frequency signal to a selected passive band-pass filter among the plurality of passive band-passed filters based on the challenge bit. The latch outputs a response bit in response to the filtering performed by the selected passive band-pass filter.

### BACKGROUND

The present invention generally relates to physical unclonable functions, and more particularly, to physical unclonable function devices that leverage stochastic variations of passive elements.

In the electronics industry, security in electronic devices has become a major concern of manufacturers and users of such devices. In this regard, it is useful to be able to distinguish each electronic device, especially the integrated circuit (IC) within these devices, from each other. This is particularly true for devices such as computers, personal hand-held devices, cellular phones, chip cards, and other devices that contain sensitive information.

A physical unclonable function (PUF) device (sometimes simply referred to as a “PUF”) is an emerging hardware-based security that has a variety of applications. For example, PUFs can be used to uniquely identify a piece of hardware by providing a unique identifying signal that is difficult to counterfeit.

### SUMMARY

According to a non-limiting embodiment, a physical unclonable function (PUF) device comprises a ring oscillator configured to generate a frequency signal, and a plurality of passive band-pass filters. Each passive band-pass filter among the plurality of passive band-pass filters is configured to perform filtering on the frequency signal to one of pass the frequency signal or block the frequency signal. A demultiplexer includes an input to receive the frequency signal and a plurality of outputs in signal communication with the passive band-pass filters. The demultiplexer is configured to receive a set of challenge bits and to deliver the frequency signal to a selected passive band-pass filter among the plurality of passive band-passed filters based on the challenge bit. A latch is in signal communication with the passive band-pass filters. The latch is configured to output a response bit in response to the filtering performed by the selected passive band-pass filter.

According to another non-limiting embodiment, a physical unclonable function (PUF) device comprises a ring oscillator configured to generate a frequency signal, and a plurality of passive band-pass filters configured to receive the frequency signal. Each passive band-pass filter among the plurality of passive band-pass filters performs filtering on the frequency signal to generate a filtered output indicative of one of passing the frequency signal or blocking the frequency signal. The PUF device further includes a plurality of latches and a plurality of multiplexers. Each latch is in signal communication with one of the passive band-pass filters to receive the filtered output and to generate a logic value based one the filtered output. Each multiplexer includes a first input configured to receive the logic value from a first latch among the plurality of latches, a second input configured to receive the logic value from a second latch among the plurality of latches, and a selector input configured to receive a challenge bit.

According to yet another non-limiting embodiment, a method of generating a challenge-response pair from a physical unclonable function (PUF) device comprises delivering a frequency signal to a demultiplexer, and inputting a set of challenge bits to the demultiplexer. The method further includes outputting the frequency signal from a selected output among the plurality of outputs of the demultiplexer to a corresponding passive band-pass filter based on the set of challenge bits. The method further comprises filtering, via the corresponding pass band-pass filter, the frequency signal to one of pass the frequency signal to a latch or block the frequency signal from the latch and outputting, via the latch, a set of response bits based on the filtering performed by the passive band-pass filter in signal communication with the selected output of the demultiplexer.

Additional features and advantages are realized through techniques described herein. Other embodiments and aspects are described in detail herein. For a better understanding, refer to the description and to the drawings.

### BRIEF DESCRIPTION OF THE DRAWINGS

The subject matter which is regarded as embodiments is particularly pointed out and distinctly claimed in the claims at the conclusion of the specification. The foregoing and other features and advantages of the embodiments are apparent from the following detailed description taken in conjunction with the accompanying drawings in which:

FIG. 1 depicts a schematic diagram of a band-pass filter according to a non-limiting embodiment of the invention;

FIG. 2 is a diagram of a frequency response of the band-pass filter shown in FIG. 1 according to a non-limiting embodiment of the invention;

FIG. 3 depicts a schematic diagram of a PUF device according to a non-limiting embodiment of the invention; and

FIG. 4 depicts a schematic diagram of a PUF device according to another non-limiting embodiment of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the described embodiments, the various elements illustrated in the figures are provided with two or three digit reference numbers. With minor exceptions, the leftmost digit(s) of each reference number correspond to the figure in which its element is first illustrated.

### DETAILED DESCRIPTION

As described herein, a physical unclonable function (PUF) is a function that maps a set of challenges to a set of expected responses based on an intractably complex physical system. The function can only be evaluated with the physical system, and is unique for each physical instance. One technique of establishing a PUFs is based on the unique timing and delay information that are inherent to integrated circuits (IC s). For example, the manufacturing processes used to an electrical component such as a transistor, for example, produces inherent variations that are unique to each fabricated device and produce unique timing delays when employed in different ICs. These timing delays can be determined during testing and used to generate an index or “map” of one or more “challenges” to a one or more expected “responses.” The responses can establish a digital finger print” that serves as a unique identifier for a given device (e.g., an IC). The usage of active devices such as transistors or other active semiconductor devices, however, introduces some limitations in terms of devices sensitivity variations caused by temperature changes, supply voltage variations and/or aging. These variations in device sensitivity can cause inaccurate outputs such as “bit flips”, which can produce inaccurate responses to an input challenge.

Turning now to an overview of technologies that are more specifically relevant to aspects of the present invention, . . . .

Turning now to a more detailed description of the inventive teachings, one or more non-limiting embodiments of the present invention provide a passive-based PUF device that implements one or more passive bandpass filters. Each passive band-pass filter is constructed using passive elements. In one or more non-limiting embodiments of the invention, the passive band-pass filters can be constructed using a combination of resistors and capacitors.

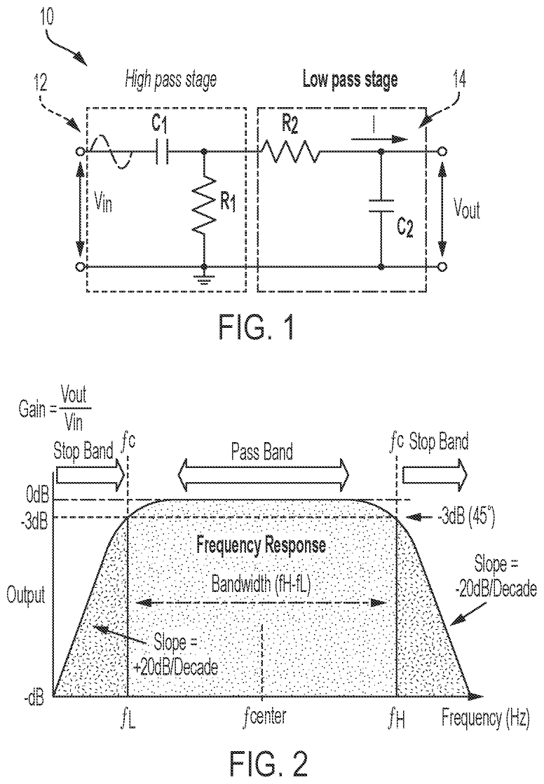

FIG. 1, for example, illustrates a second order band-pass filter 10 that can be utilized as a passive band-pass filter included in a passive-based PUF device according to one or more non-limiting embodiments of the present invention. The second order band-pass filter 10 includes a first resistor-capacitor (RC) circuit defining a high-pass stage 12 and a second RC circuit defining a low-pass stage 14. The first RC circuit of the high-pass stage 12 includes a first capacitor (C1) having first terminal connected to an AC input voltage (Vin) and a second terminal connected to a first resistor (R1). The second terminal of the first resistor is connected to a ground potential. The second RC circuit of the low-pass stage 14 includes a second resistor (R2) and a second capacitor (C2). The second resistor (R2) has a first terminal connected in common with the second terminal of the first capacitor (C1) and the first terminal of the first resistor (R1). The second terminal of the second resistor (R2) is connected in common to a first terminal of the second capacitor (C2) and an output voltage (Vout) or a load. The second terminal of the second capacitor (C2) is connected to the ground potential.

FIG. 2 illustrates an example of a frequency response associated with a second order band-pass filter shown in FIG. 1. The bandwidth (f_{H}−f_{L}) of the band-pass filter can be expressed according to the following equation:

$${f}_{H} - {f}_{L} = \frac{1}{2 π {R}_{2} {C}_{2}} - \frac{1}{2 π {R}_{1} {C}_{1}} , \qquad [ Eq . 1 ]$$

where f_{L} is the low-end threshold of the pass band; f_{H} is the high-end threshold of the pass band; R1 is the resistance value of resistor R1, C1 is the capacitance value of capacitor C1; R2 is the resistance value of resistor R2; and C2 is the capacitance value of capacitor C2.

The second order band-pass filter can be utilized to facilitate a PUF by selecting the resistor and capacitor values of the high-pass stage and the low-pass stage so that nominally f_{H} will match f_{L}, i.e., f_{H}=f_{L}, thereby setting the nominal bandwidth of the band-pass filter to zero. Due to the inherent stochastic variations of the resistors and capacitors, however, the actual bandwidth of the bandpass filters will follow a normal distribution. Thus, fifty percent of the of the bandpass filters utilized in a PUF device will have a positive bandwidth (i.e., f_{H}>f_{L}), while the remaining fifty percent of the bandpass filters will have a negative bandwidth (i.e., f_{f}/f_{L}). Accordingly, pre-testing can be performed on the bandpass filters utilized in a PUF device and the outputs of the bandpass filters in response to receiving a frequency signal that exceeds f_{H} can be determined and recorded (e.g., stored in memory of a controller) for future reference. The outputs obtained from pre-testing can then be used to determine an expected response signal. The response signal can define an authentic digital finger print, which can be compared (e.g., via a controller) to an actual response signal generated by the bandpass filters at a future date to authenticate the PUF device as described in greater detail below.

The passive PUF device can be challenged by inputting frequency signal to a selected combination of bandpass filters, and each challenged bandpass filter will either pass the high frequency component of the frequency signal if f_{H}>f_{L}, or block the high frequency component of the frequency signal. A latch can then be utilized to compare the output of the challenged band-pass filter to a reference value (e.g., “0”). When the input to the latch is high, the latch outputs a logic 1 value or a “1” bit. When, however, the input to the latch is low, the latch outputs a logic 0 value or a “0” bit. Accordingly, a combination of challenged bandpass filters can be utilized to generate a result that includes a set of response bits. As described herein, the resulting response bits can then be compared (via a controller) to the pre-determined output of each challenged bandpass filter. When the actual result (the actual sequence of bits) matches the expected result (i.e., the authentic digital finger print), the device implementing the passive PUF is determined to be authentic. When, however, the actual result does not match (i.e., is mis-matched) the expected result, the device implementing the passive PUF is determined to be compromised.

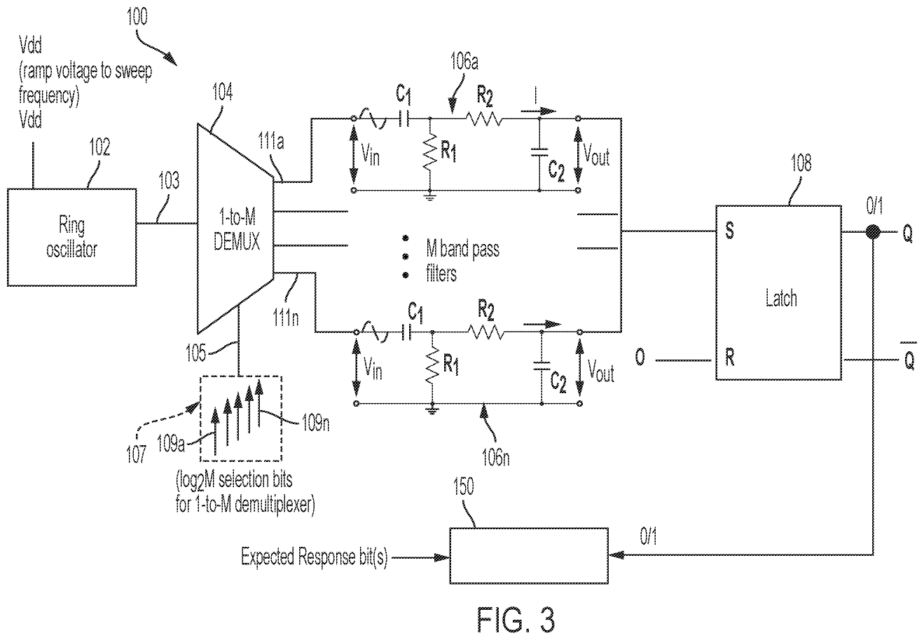

Turning now to FIG. 3, a passive PUF device 100 is illustrated according to a non-limiting embodiment of the invention. The passive PUF device 100 includes a ring oscillator 102, a demultiplexer (DMUX) 104, a plurality of passive band-pass filters 106a-106n, and a latch 108. In this example, the passive PUF device 100 implements a single latch, which allows for producing a small number of possible challenge-response pairs (e.g., 32 challenge-response pairs). Therefore, the passive PUF device 100 illustrated in FIG. 3 is referred to herein as a “weak PUF.”

The ring oscillator 102 outputs a frequency signal in response to an input supply voltage (Vdd). The frequency of the output frequency signal is based on the level of the supply (Vdd). Therefore, the frequency of the output frequency can be varied from a selected low frequency to a selected high frequency in response to increasing the supply voltage from a first voltage level (e.g., 0 volts) to a higher second voltage level. The DMUX 104 is disposed upstream from the passive band-pass filters 106a-106n and includes a first input 103, a selector input 105, and a plurality of selectable outputs 111a-111n. The first input 103 is configured to receive the frequency signal generated by the ring oscillator 102. The selector input 105 is configured to receive a challenge signal. Each selectable output 111a-111n is connected to an input of a respective passive band-pass filter 106a-106n.

The challenge signal 107 includes one or more bits 109a-109n (i.e., a binary digit) configured to select a target passive band-pass filter 106a-106n. In one or more non-limiting embodiments of the invention, the challenge signal 107 includes a set (e.g., plurality) of bits 109a-109n so that the binary value of each combination set by the plurality of bits 109a-109n corresponds to a unique passive band-pass filter in the set 106a-106n. For example, the challenge signal 107 can include log 2M selection bits 109a-109n for a 1-to-M DEMUX. Thus, a device 100 including thirty-two (32) band-pass filters utilizes a challenge signal 107 including five (5) bits 109a-109n to generate 32 distinct challenge-response pairs. Accordingly, the state of each bit 109a-109n (either a “0” bit or a “1” bit) effectively controls the DMUX 104 to route the ring oscillator output to one of the corresponding passive band-pass filters 106a-106n.

The selected passive band-pass filter from the set 106a-106n performs filtering on the frequency signal as the frequency is ramped up beyond the high-end threshold (f_{H}) of the band-pass filters 106a-106n. As described herein, fifty percent of the of the bandpass filters 106a-106n will have a positive bandwidth (e.g., f_{H}>f_{L}) and will output (i.e., “pass) a frequency signal having a frequency that exceeds f_{H}, while the remaining fifty percent of the bandpass filters 106a-106n will have a negative bandwidth (e.g., f_{H}<f_{L}) and will block a frequency signal having a frequency that exceeds f_{H}.

The latch 108 includes a reset input (R), a set input (S), and a latch output (Q). The reset input (R) is set to a fixed low input (e.g., a logic “0” input). The set input (S) is connected each output of the passive band-pass filters 106a-106n and receives the output of a respective selected band-pass filter 106a-106n. Accordingly, the latch 108 outputs a “response” bit of either a logic “1” in response to a given band-pass filter outputting a “high” output signal (i.e., passing the frequency signal generated by the ring oscillator 102) or a logic “0” in response to a given band-pass filter 106a-106n outputting a “low” output signal (i.e., blocking the frequency signal generated by the ring oscillator 102).

To authentic the PUF device 100, the latch 108 sequentially receives the output signal (either a passed frequency signal or a blocked frequency signal) from each sequentially activated passive band-pass filter 106a-106n and generates a response bit at the latch output (Q) corresponding to the state of the output signal output from a given selected band-pass filter (e.g., passive band-pass filters 106a, 106c and 106n). The set of response bits defines an actual response signal, which can be compared to the expected response signal corresponding to the selected band-pass filters (e.g., passive band-pass filters 106a, 106c and 106n). In one or more non-limiting embodiments of the invention, a controller 150 stores the pre-determined expected response bits for each passive band-pass filter 106a-106n, and is configured to compare an actual response bit to the pre-determined response bit. When the response bits of the actual response signal match the response bits of the expected response signal, the PUF device 100 is determined to be authentic. When, however, the response bits of the actual response signal do not match (i.e., are mis-matched) the response bits of the expected response signal, the PUF device 100 is determined to be compromised.

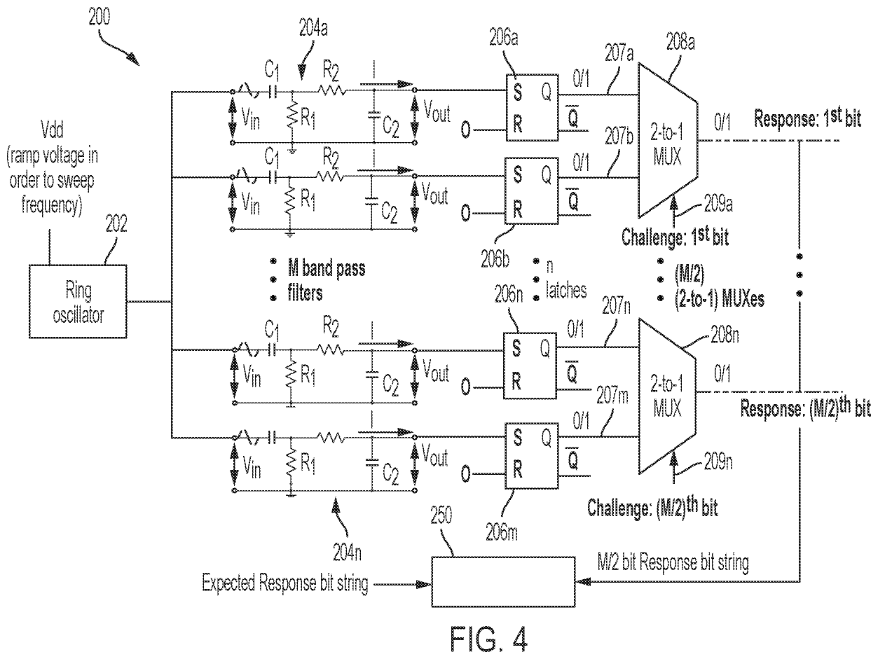

Referring to FIG. 4, a passive PUF device 200 is illustrated according to another non-limiting embodiment of the invention. The passive PUF device 200 includes a ring oscillator 202, a plurality of passive band-pass filters 204a-204n, a plurality of latches 206a-206m, and a plurality of multiplexers (MUXs) 208a-208n. The ring oscillator 202, passive band-pass filters 204a-204n, each latch 206a-206m operate as described in detail above. Therefore, various details of their operations will not be repeated for the sake of brevity. The plurality of latches 206a-206m used in combination with the plurality of multiplexers (MUXs) 208a-208n, however, allows for inputting a substantially larger number of possible challenge-response pairs (e.g., 65,536 challenge-response pairs) compared to the weak PUF 100 illustrated in FIG. 3. Therefore, the passive PUF device 200 illustrated in FIG. 4 is referred to herein as a “strong PUF.”

The ring oscillator 202 outputs a frequency signal in parallel to each of the passive band-pass filters 204a-204n. Accordingly, the passive band-pass filters 204a-204n perform filtering on the frequency signal as the frequency is ramped up beyond the high-end threshold (f_{H}). As described herein, fifty percent of the of the bandpass filters 204a-204n have a positive bandwidth (e.g., f_{H}>f_{L}) and output (i.e., “pass) the frequency signal when its frequency exceeds f_{H}, while the remaining fifty percent of the bandpass filters 204a-204n have a negative bandwidth (e.g., f_{H}<f_{L}) and block the frequency signal when its frequency exceeds f_{H}.

Each latch 206a-206m receives the output from a respective passive band-pass filters 204a-204n. Based on the state of the output provided by a respective passive band-pass filter 204a-204n, each latch 108 outputs a “response” bit of either a logic “1” or a logic “0”. In one or more non-limiting embodiments of the invention, the latches latch 206a-206m generate their outputs (Q) in parallel with one another.

With continued reference to FIG. 4, each MUX 208a-208n can be assigned to a pair of latches from the set 206a-206m. For example, when “m” is 32 (i.e., the PUF device 200 implements 32 passive band-pass filters), then the PUF device 200 can implement m/2 MUXs, i.e., 16 MUXs. Accordingly, MUX 208a includes a first input 207a configured to receive the output (Q) from latch 206a, a second input 207b configured to receive the output (Q) from latch 206b, and a selector input 209a configured to receive a first challenge signal. Likewise, MUX 208n includes a first input 207n configured to receive the output (Q) from latch 206n, a second input 207m configured to receive the output (Q) from latch 206m, and a selector input 209n configured to receive an “n^{th}” challenge signal.

The PUF device 200 utilizes a challenge signal that includes a plurality of challenge bits. In one or more non-limiting embodiments of the invention, the challenge signal includes m/2 challenge bits. In the example, where the PUF device 200 implements 32 passive band-pass filters (i.e., M=32), the challenge signal includes 16 bits. Each bit is either a logic “0” or a logic “1”, and is used to select the input of a given MUX 208a-208n. For example, inputting a logic “0” challenge bit to selector input 209a causes MUX 208a to select the first input 207a and output the logic value generated by the first latch 206a. However, inputting a logic “1” challenge bit to selector input 209a causes MUX 208a to select the second input 207b and output the logic value generated by the second latch 206b. Accordingly, the logic value output by a given MUX 208a-208n effectively represents a response bit corresponding to the challenge bit input to the selector input 209a-209n of the given MUX 208a-208n.

The string of response bits output from the MUXs 208a-208n defines an actual response signal, which can be compared to an expected response signal, i.e., the expected values of the response bits determined when performing pre-testing on the passive band-pass filters 204a-204n of the PUF device 200. In one or more non-limiting embodiments of the invention, a controller 250 stores the pre-determined expected responses for each passive band-pass filter 206a-206n. Accordingly, the controller 250 can compare the response bits of an actual response signal to the expected response bits. When the response bits of the actual response signal match the expected response bits, the PUF device 200 is determined to be authentic. When, however, the response bits of the actual response signal do not match the expected response bits, the PUF device 200 is determined to be compromised.

As described herein, various non-limiting embodiment of the present invention provide a passive-based PUF device that implements one or more passive bandpass filters. Each passive band-pass filter is constructed using passive elements, e.g., a combination of resistors and capacitors, which are much more resilient against behavior variations caused by temperature, supply voltage variations and/or aging compared to active components. As a result, a more robust and accurate passive-based PUF device is provided compared to conventional active-based PUF devices.

Various embodiments of the present invention are described herein with reference to the related drawings. Alternative embodiments of the present invention can be devised without departing from the scope of this invention. Although various connections and positional relationships (e.g., over, below, adjacent, etc.) are set forth between elements in the detailed description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Similarly, the term “coupled” and variations thereof describes having a communications path between two elements and does not imply a direct connection between the elements with no intervening elements/connections between them. All of these variations are considered a part of the specification. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The phrase “selective to,” such as, for example, “a first element selective to a second element,” means that the first element can be etched and the second element can act as an etch stop.

The term “conformal” (e.g., a conformal layer) means that the thickness of the layer is substantially the same on all surfaces, or that the thickness variation is less than 15% of the nominal thickness of the layer.

As previously noted herein, for the sake of brevity, conventional techniques related to semiconductor device and IC fabrication may or may not be described in detail herein. By way of background, however, a more general description of the semiconductor device fabrication processes that can be utilized in implementing one or more embodiments of the present invention will now be provided. Although specific fabrication operations used in implementing one or more embodiments of the present invention can be individually known, the described combination of operations and/or resulting structures of the present invention are unique. Thus, the unique combination of the operations described in connection with the fabrication of a semiconductor device according to the present invention utilize a variety of individually known physical and chemical processes performed on a semiconductor (e.g., silicon) substrate, some of which are described in the immediately following paragraphs.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A physical unclonable function (PUF) device comprising:
a ring oscillator configured to generate a frequency signal;
a demultiplexer including an input to receive the frequency signal and a plurality of outputs in signal communication with the passive band-pass filters, the demultiplexer configured to receive a set of challenge bits and to deliver the frequency signal to a selected output among the plurality of outputs s based on the set of challenge bits;
a plurality of passive band-pass filters, each passive band-pass filter among the plurality of passive band-pass filters including an input in signal communication with a respective output of the demultiplexer and configured to perform filtering on the frequency signal received from the respective output to one of pass the frequency signal or block the frequency signal; and
a latch in signal communication with the passive band-pass filters, the latch configured to output a response bit in response to the filtering performed by the selected passive band-pass filter.

2. The PUF device of claim 1, wherein each of the passive band-pass filters comprises:
a first resistor-capacitor circuit that defines a high-pass stage of the passive band-pass filter; and
a second resistor-capacitor circuit connected to the first resistor-capacitor circuit, the second resistor-capacitor circuit defining a low-pass stage of the passive band-pass filter.

3. The PUF device of claim 1 further comprising a controller configured to compare an expected response bit associated with the selected passive band-pass filter to the response bit output by the selected passive band-pass filter.

4. The PUF device of claim 3, wherein the latch outputs one of a logic “1” bit in response to the selected passive band-pass filter passing the frequency signal or a logic “0” bit in response to the selected passive band-pass filter blocking the frequency signal.

5. The PUF device of claim 4, wherein the set of challenge bits define a challenge signal, and wherein the demultiplexer delivers the frequency signal to the selected passive band-pass filter based on the challenge signal.

6. The PUF device of claim 5, wherein the selected passive band-pass filters collectively generate a set of response bits based on the set of challenge bits, the set of response bits defining an actual response signal.

7. The PUF device of claim 6, wherein the controller determines an expected response signal including a sequence of expected response bits based on the group of selected band-pass filters, and determines an authenticity of the PUF device based on a comparison between the actual response signal and the expected response signal.

8. The PUF device of claim 7, wherein the controller determines the PUF device is authentic in response to the response bits of the actual response signal matching the expected response bits of the expected response signal, and determines the PUF device is compromised in response to the response bits of the actual response signal mis-matching the expected response bits of the expected response signal.

9. A physical unclonable function (PUF) device comprising:
a ring oscillator configured to generate a frequency signal;
a plurality of passive band-pass filters configured to receive the frequency signal, each passive band-pass filter among the plurality of passive band-pass filters configured to perform filtering on the frequency signal to generate a filtered output indicative of one of passing the frequency signal or blocking the frequency signal;
a plurality of latches, each latch in signal communication with one of the passive band-pass filters to receive the filtered output and to generate a logic value based one the filtered output; and
a plurality of multiplexers, each multiplexer including a first input configured to receive the logic value from a first latch among the plurality of latches, a second input configured to receive the logic value from a second latch among the plurality of latches, and a selector input configured to receive a challenge bit.

10. The PUF device of claim 9, wherein each multiplexer is configured to selectively output one of the logic value from the first latch or the logic value from the second latch based on the challenge bit, the selected logic value indicative of a response bit to the challenge bit.

11. The PUF device of claim 10, wherein each of the passive band-pass filters comprises:
a first resistor-capacitor circuit that defines a high-pass stage of the passive band-pass filter; and
a second resistor-capacitor circuit connected to the first resistor-capacitor circuit, the second resistor-capacitor circuit defining a low-pass stage of the passive band-pass filter.

12. The PUF device of claim 10, wherein a combination of the challenge bits defines a challenge signal that selects a combination of latches among the plurality of latches to generate.

13. The PUF device of claim 12, wherein the combination of latches generates a plurality of response bits that define a response signal corresponding to the challenge signal.

14. The PUF device of claim 13, wherein a controller determines an expected response signal including a sequence of expected response bits corresponding to the combination of latches, and determines an authenticity of the PUF device based on a comparison between the actual response signal and the expected response signal.

15. The PUF device of claim 14, wherein the controller determines the PUF device is authentic in response to the response bits of the actual response signal matching the expected response bits of the expected response signal, and determines the PUF device is compromised in response to the response bits of the actual response signal mis-matching the expected response bits of the expected response signal.

16. A method of generating a challenge-response pair from a physical unclonable function (PUF) device, the method comprising:
delivering a frequency signal to a demultiplexer;
inputting a set of challenge bits to the demultiplexer;
outputting the frequency signal from a selected output among the plurality of outputs of the demultiplexer to a corresponding passive band-pass filter based on the set of challenge bits;
filtering, via the corresponding pass band-pass filter, the frequency signal to one of pass the frequency signal to a latch or block the frequency signal from the latch; and
outputting, via the latch, a set of response bits based on the filtering performed by the passive band-pass filter in signal communication with the selected output of the demultiplexer.

17. The method of claim 16 further comprising comparing, via a controller, an expected response bit associated with the passive band-pass filter in signal communication with the selected output, to the response bit output by the passive band-pass filter in signal communication with the selected output.

18. The method of claim 17 further comprising outputting from the latch one of a logic “1” bit in response to the selected passive band-pass filter passing the frequency signal or a logic “0” bit in response to the selected passive band-pass filter blocking the frequency signal.

19. The method of claim 18, wherein a group of the passive band-pass filters generate connected to the selected outputs of the demultiplexer a set of generates the set of response bits based on the set of challenge bits to define an actual response signal.

20. The method of claim 19, further comprising:
determining, via the controller, the expected response signal including a sequence of expected response bits based on the group of selected band-pass filters; and
determining, via the controller, an authenticity of the PUF device based on a comparison between the actual response signal and the expected response signal.
